(19) United States
(12) Patent Application Publication
(10) Pub. No.: US 2006/0101108 A1
(43) Pub. Date: May 11, 2006

(54) Using a leading-sign anticipator circuit for detecting sticky-bit information

(75) Inventors: Sang Hoo Dhong, Austin, TX (US); Christian Jacobi, Boblingen (DE); Silvia Melitta Mueller, Altdorf (DE); Hwa-Joon Oh, Austin, TX (US); Yonetaro Totsuka, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignees: International Business Machines Corporation, Armonk, NY (US); Sony Computer Entertainment Inc., Tokyo (JP)

(21) Appl. No.: 10/982,119

(22) Filed: Nov. 5, 2004

(51) Int. Cl. G06F 7/50

(52) U.S. Cl. 708/670

(57) ABSTRACT

A method, an apparatus, and a computer program are provided to more efficiently generate a sticky bit in a Floating Point Design. Traditionally, separate ORing logic or OR trees were employed to compress the stick outputs of a normalization shifter into at least one sticky bit. However, this design has power consumption and area costs associated with it. To overcome these disadvantages, the OR trees of Leading Zero Counters (CLZs) are employed in conjunction with the Edge Vector logic of a Leading Sign Anticipator and an additional OR gate to determine the sticky bit.

### TECHNICAL FIELD

The present invention relates generally to the field of Floating Point Units (FPUs) and, more particularly, detecting sticky-bit information from Leading-Sign Anticipator (LSA) information.

### BACKGROUND OF THE INVENTION

Modern electronic devices often employ FPUs to perform calculations on numbers that can result in a variable number of whole integer digits, specifically binary FPUs. In many floating-point unit calculations, intermediate results can occur with bit-lengths that are subsequently compressed to match a bit-length, or width, of a target floating-point format. For example, in double-precision FPUs, intermediate results of 160 bits in width are often compressed to 53 bits.

Referring to FIG. 1 of the drawings, the reference numeral 100 generally designates a conventional portion of an FPU. The portion 100 comprises an intermediate result 102, a Leading Sign Anticipator 104, an adder 108, an incrementer 106, a normalization shifter 110, a multiplexer (mux) 112, and ORing logic 114.

An upper pipeline typically provides the intermediate result 102. The intermediate is comprised of three parts corresponding to the Most Significant Bits (MSB), the Middle Bits (MB), and the Least Significant Bits (LSB) The MSB is usually in standard binary representation that is transmitted to the incrementer 106 through the communication channel 116. The MB and LSB, however, are typically in a redundant carry-save representation that are transmitted to the adder 108 and the LSA 104 through communications channels 118 and 120, respectively.

The adder 108 and the incrementer 106 can then perform an operation on the intermediate result. Additionally, the LSA 104, in parallel to the adder 108, anticipates the number of leading-sign bits in the output from the adder 108. The anticipation result from the LSA 104 is transmitted to the mux 112 through communication channel 124. The mux 112 also receives the shift-amount from the exponent through the communication channel 126. The normal shift amount can then be transmitted to the normalization shifter 110 through the communication channel 128 in addition to output (typically the absolute value of the sum) of the incrementer 106 and adder 108 through the communication channel 122. Therefore, the operational result and the shift amount can be received at the normalization shifter 110 at about the same time so that the number of leading-signs can be shifted out.

The result of the shifting performed by the normalization shifter 110 can then be utilized to compute the sticky bit as well as other information. Some of the shifted result, typically more significant bits that constitutes the normalized result, are transmitted to the rounder (not shown) through the communication channel 132, and the normalization shifter 110 transmits less significant bits to the OR logic 114 through communication channel 130. The shift performed by the normalization shifter 110, however, is normally between 160 places to the left and 54 places to the right, for double precision numbers. Therefore, there are a large number of bits that are compressed into a sticky bits causing the OR logic 114 to be relatively large.

Referring to FIG. 2 of the drawings, the reference numeral 200 generally designates a conventional LSA. The LSA 200 comprises an LSA edge vector creator 202 and Leading Zero Counter (CLZ) 204.

The LSA 200 utilizes the creator 202 to rapidly anticipate an edge vector for the MB and the LSB of an intermediate result, which are received through the communication channels 206 and 208. The edge vector has a ‘1’ for every position where the sum has an edge, where an edge is a position that a transition from ‘0’ to ‘1’ or ‘1’ to ‘0’ occurs. For example, 00011101 has an edge at the fourth position.

As an example, consider two inputs, A and B (not shown), are input into the creator 202 that are input through the communication channels 206 and 208. The creator 202 then computes an edge vector, which reflects the location of the leading 1. The edge vector, however, may have an error associated with it; there may be error in calculating the leading zeros, but the error is no greater than 1. As an example, the following equations illustrate edge vector computations:
A=00001000
B=00000000
A+B=00001000
E=00001xxx
where A and B are input vectors and E is the edge vector. The edge vector anticipates the number of leading zeros but can be off by one position to the right.

For example, consider the inputs A′ and B′. The following equations illustrate edge vector computations:
A′=00000001
B′=00000111
A′+B′=00001000
E′=000001xx
It is clear that the A+B and A′+B′ are equal, but the E′ is off by one position to the right. Therefore, an edge vector is only fully defined for a given set of intermediate results, such as vectors A and B.

Once the edge vector is computed, then the edge vector is transmitted to the CLZ 204 through the communication channel 210. The CLZ calculates the number of leading-sign bits of the sum of the inputs transmitted to the creator 202 through the communication channels 206 and 208 with a possible over-estimation by one.

In most conventional designs, it is common to have the OR logic 114 incorporated into the normalization shifter 110. However, separate combinatorial hardware is still used to computer the sticky bits. This hardware can occupy a substantial amount of area and can consume a substantial amount of power. Therefore, there is a need for a system and/or method for floating-point unit computation that addresses at least some of the problems associated with conventional systems and methods.

### SUMMARY OF THE INVENTION

The present invention provides a method and a computer program for determining a stick bit in a Floating-Point-Design. An edge vector is first generated from an intermediate result. At least one pre-sticky bit is computed by employing logic of a CLZ based on the edge vector. Then, the at least one pre-sticky bit is logically combined with adder outputs.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a portion of an FPU that includes an LSA;

FIG. 2 is a block diagram depicting a conventional LSA;

FIG. 3 is a block diagram depicting a modified LSA; and

FIG. 4 is a flow chart depicting the operation of the modified LSA.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

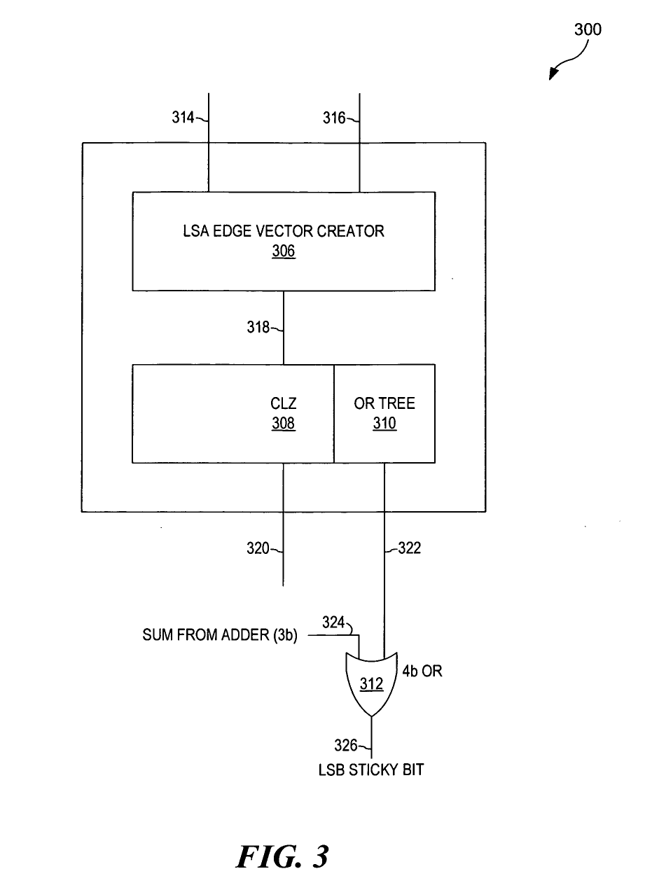

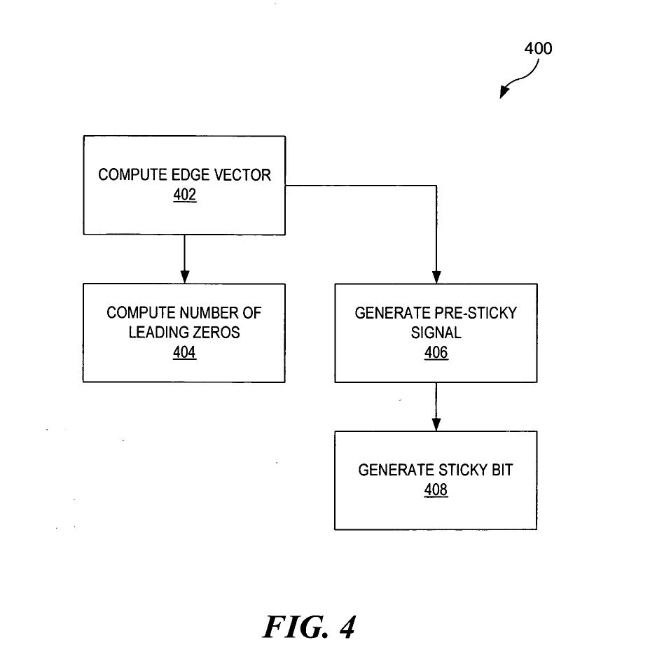

Referring to FIGS. 3 and 4 of the drawings, the reference numerals 300 and 400 generally designate a modified LSA and its operation, respectively. The LSA 300 comprises an edge vector creator 306, a CLZ 308, and a 4-bit OR gate 312.

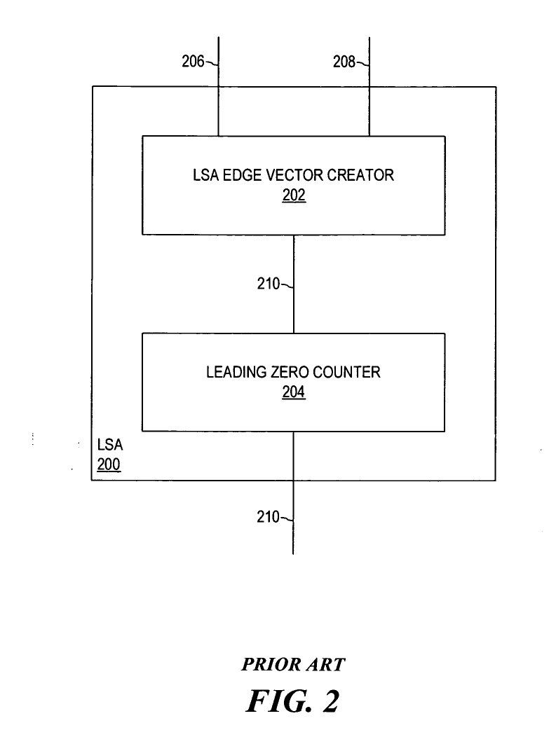

As with the conventional LSA 200 of FIG. 2, the creator 306 receives the MB and the LSB of an intermediate result. The creator 306 generates an edge vector in step 402 and transmits the edge vector to the CLZ 308 through the communication channel 318. Also, as with the conventional LSA 200, the CLZ computes the number of leading-sign bits in step 404, which are output through the communication channel 320.

However, the CLZ 308 is different from the CLZ 204 of FIG. 2 in that the CLZ 308 includes an OR tree 310. The OR tree 310 ORs the least significant bits of the edge vector together to yield a pre-sticky signal in step 406. If there is an edge somewhere within the sticky range, which implies that there is a ‘1’ in the sum, one of the edge vector bits will be ‘1.’ Therefore, the pre-sticky signal will equal the sticky bit of the less significant bits of the MB and LSB input through the communication channels 314 and 316 except for three cases.

In the first case, the creator 306 examines 3-bit windows to determine the edge vector. For example, bit 53 is obtained by examining bits 51 through 53. Therefore, the two most significant bits of the edge vector collected in the sticky bit may be incorrect due to overlap with more significant bits that should have no effect on the sticky bit calculation.

The second case is where the actual leading count of the sum of the MB and LSB that are input through the communication channels 314 and 316 can be one less than the estimate of the LSA 300. For example, in a case where the edge vector is all zeros, there can be a least significant bit of the sum that is equal to ‘1.’ Under these circumstances, the LSA 300 mis-predicts the edge.

Finally, in the third case, the sum contains only ‘1’s. Under these circumstances, there is no edge in the sum, yielding an edge vector with all ‘0’s. Hence, the pre-sticky signal would also be equal to zero; even through the sum is not ‘0.’

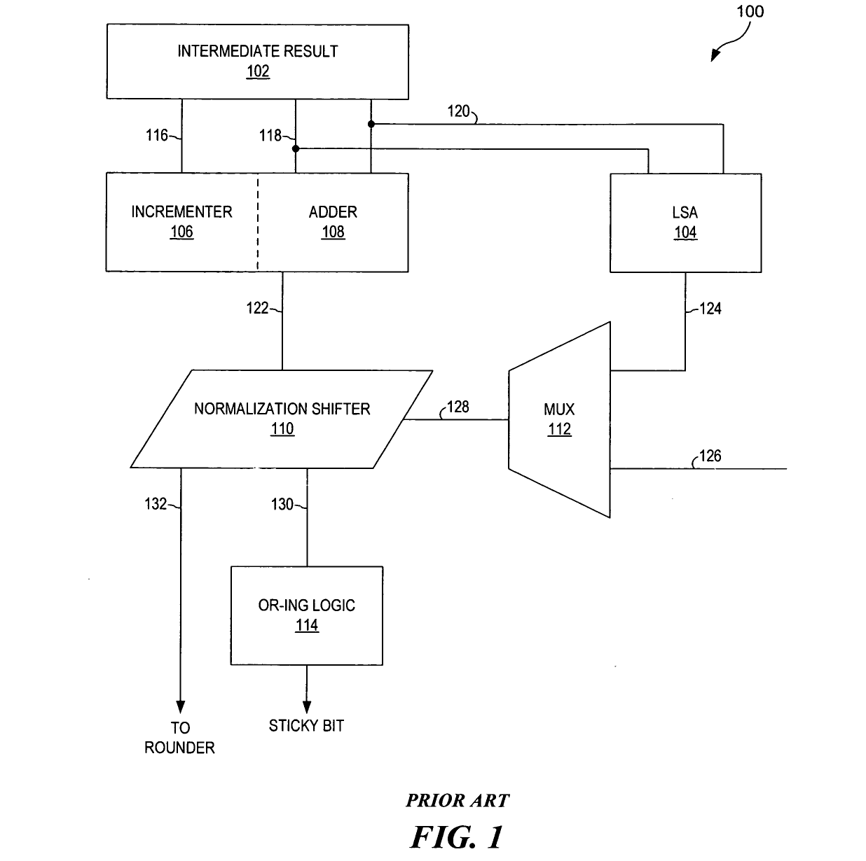

To correct the resulting error of each of the three cases, an additional 4-bit OR gate 312 is employed. The OR gate 312 receives the pre-sticky signal through the communication channel 322 and receives three bits from the sum of the adder, such as the adder 108 of FIG. 1, through the communication channel 324 in step 408. The three bits from the sum are comprised of the two most significant bits in the sticky range and the least significant bit in the sticky range. The result of the OR gate 312, which is communicated through the communication channel 326, is the correct sticky bit for the LSB input.

Therefore, by utilizing the two most significant bits in the sticky range, some of the bits in the edge vector can be ignored. For example, instead of ORing the least significant 53 bits of an edge vector, the least significant 51 bits are ORed in determining the pre-sticky signal. Hence, the incorrect result pre-sticky bit due to overlap can be eliminated.

By utilizing the least significant bit in the sticky range, the errors that results in the second and third case can be eliminated. In both cases, the pre-sticky bit is incorrectly determined to be ‘0.’ The least significant bit in the sticky range can force the sticky bit that is output through the communication channel 326 to be ‘1.’

Additionally, in conventional implementations of the CLZ, such as the CLZ 204, most of the OR tree, such as the OR tree 310, is in use. Specifically, the conventional CLZs compute piecewise zero-signals of edge vectors. Therefore, the existing OR logic can be reused for the computation of the pre-sticky signal.

Therefore, the improved LSA allows for a reduction in the occupied area as well as reduced power consumption. By moving the ORing logic 114 into the CLZ in order to utilize exiting OR trees, the ORing logic 114 can be significantly reduced, which reduces occupied area and power consumption. Oftentimes, too, the logic of FIG. 1 is divided into pipeline stages separated by latches; however, the computation of the pre-sticky bit, as provided by the improved LSA 300, allows for a reduction in the number of latches, which reduces occupied area and power consumption. Additionally, this design can not only be applied to a LSA, but with some modifications the implementation could be applied to a Leading Zero Anticipator.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

What is claimed is:

1. A leading sign anticipator (LSA), comprising:
an edge vector module that is at least configured to generate an edge vector from at least two inputs; and
a leading zero counter (CLZ) that is at least configured to compute a number of leading zeros from the edge vector and that is at least configured to generate at least one pre-sticky bit from the edge vector.

2. The LSA of claim 1, wherein the CLZ is at least configured to employ at least one OR tree to generate the at least one pre-sticky bit.

3. The LSA of claim 1, wherein the LSA further comprises an OR gate that is at least configured to generate at least one sticky bit from the at least one pre-sticky bit and a plurality of bits from an output of an adder.

4. The LSA of claim 3, wherein the OR gate further comprises a 4-bit OR gate.

5. The LSA of claim 3, wherein the OR gate is at least configured to receive at least two most significant bits in a sticky region of the output of the adder.

6. The apparatus of claim 3, wherein the OR gate further is at least configured to receive at least one least significant bit in a sticky region of the output of the adder.

7. A Floating-Point-Design, comprising:
an adder that is at least configured to receive an intermediate result;
an LSA that is at least configured to determine a number of leading sign bits in an output of the adder and that is at least configured to generate at least one sticky bit; and
a normalization shifter that is at least configured to employ the output of the adder and an output of the LSA to generate a normalized result.

8. The Floating-Point-Design of claim 7, wherein the adder further comprises:
an incrementer that is at least configured to increment for the most significant bits of the intermediate result; and
an true adder that is at least configured to add the middle bits and the least significant bits of the intermediate result.

9. The Floating-Point-Design of claim 7, wherein the LSA further comprises:
an edge vector module that is at least configured to generate an edge vector from at least two inputs from the intermediate result; and
a leading zero counter (CLZ) that is at least configured to compute a number of leading zeros from the edge vector and that is at least configured to generate at least one pre-sticky bit from the edge vector.

10. The Floating-Point-Design of claim 9, wherein the CLZ is at least configured to employ at least one OR tree to generate the at least one pre-sticky bit.

11. The Floating-Point-Design of claim 9, wherein the LSA further comprises an OR gate that is at least configured to generate at least one sticky bit from the at least one pre-sticky bit and a plurality of bits from an output of an adder.

12. The Floating-Point-Design of claim 11, wherein the OR gate further comprises a 4-bit OR gate.

13. The Floating-Point-Design of claim 9, wherein the OR gate is at least configured to receive at least two most significant bits in a sticky region of the output of the adder.

14. The Floating-Point-Design of claim 9, wherein the OR gate further is at least configured to receive one least significant bit in a sticky region of the output of the adder.

15. A method for determining a stick bit in a Floating-Point-Design, comprising:
generating an edge vector from an intermediate result;
computing at least one pre-sticky bit by employing logic of a CLZ based on the edge vector; and
logically combining the at least one pre-sticky bit with adder outputs.

16. The method of claim 15, wherein step of logically combining further comprises ORing at least two most significant bits in a sticky region of the output of the adder.

17. The method of claim 15, wherein step of logically combining further comprises ORing at least one least significant bit in a sticky region of the output of the adder with the at least one pre-sticky bit.

18. The method of claim 17, wherein step of logically combining further comprises ORing at least two most significant bits in a sticky region of the output of the adder with the at least one pre-sticky bit.

19. A computer program product for determining a stick bit in a Floating-Point-Design, the computer program product having a medium with a computer program embodied thereon, the computer program comprising:
computer code for generating an edge vector from an intermediate result;
computer code for computing at least one pre-sticky bit by employing logic of a CLZ based on the edge vector; and
computer code for logically combining the at least one pre-sticky bit with adder outputs.

20. The computer program product of claim 19, wherein computer code for logically combining further comprises computer code for ORing at least two most significant bits in a sticky region of the output of the adder.

21. The computer program product of claim 19, wherein computer code for logically combining further comprises computer code for ORing at least one least significant bit in a sticky region of the output of the adder with the at least one pre-sticky bit.

22. The computer program product of claim 21, wherein computer code for logically combining further comprises computer code for ORing at least two most significant bits in a sticky region of the output of the adder with the at least one pre-sticky bit.
